(19) United States
(12) Patent Application Publication
(10) Pub. No.: US 2024/0199140 A1
(43) Pub. Date: Jun. 20, 2024

(54) AUTOMOBILE

(71) Applicant: Isuzu Motors Limited, Yokohama-shi (JP)

(72) Inventor: Kouhei NAGAI, Fujisawa-shi (JP)

(73) Assignee: Isuzu Motors Limited, Yokohama-shi (JP)

(21) Appl. No.: 18/539,293

(22) Filed: Dec. 14, 2023

(30) Foreign Application Priority Data
Dec. 15, 2022 (JP) 2022-200141

(51) Int. Cl. B62D 25/24; B60K 11/02; B60K 15/063; B62D 33/04

(52) U.S. Cl. CPC B62D 25/24; B60K 11/02; B60K 15/063; B62D 33/04; B60K 1/04

(57) ABSTRACT

An automobile includes a space for accommodating a person or an object, and a maintenance target installed outside a constituent portion of the space, the automobile including: an opening portion in the constituent portion of the space, the opening portion being formed at a position corresponding to an installation position of the maintenance target; and a door portion allowing the opening portion to be opened and closed.

### CROSS REFERENCE TO RELATED APPLICATIONS

This application claims the benefit of priority of Japanese Patent Application No. 2022-200141, filed on Dec. 15, 2022, the contents of which are incorporated by reference as if fully set forth herein in their entirety.

### TECHNICAL FIELD

The present disclosure relates to automobiles.

### BACKGROUND ART

In general, regarding commercial vehicles provided with a space for accommodating a person or an object (for example, an interior space of a bus, a cargo compartment of a truck, or the like), parts, apparatuses, devices, and the like that need maintenance (hereinafter, referred to as maintenance targets) are mounted outside constituent portions (for example, a floor portion, a side wall portion, a ceiling portion, and the like) of the space.

For example, Patent Literature (hereinafter, referred to as “PTL”) 1 discloses an example in which maintenance targets such as a hydrogen tank, a motor, and a battery are fixed to a chassis frame disposed below a cargo compartment in a truck that is a fuel cell vehicle.

### CITATION LIST

### Patent Literature

### PTL 1

Japanese Patent Application Laid-Open No. 2022-165028

### SUMMARY OF INVENTION

### Technical Problem

In the above-described commercial vehicles, improvement in efficiency of maintenance work is desired.

An object of one aspect of the present disclosure is to provide an automobile capable of improving the efficiency of maintenance work.

### Solution to Problem

In order to achieve the above object, an automobile according to an aspect of the present disclosure is an automobile including a space for accommodating a person or an object, and a maintenance target installed outside a constituent portion of the space, the automobile including: an opening portion in the constituent portion of the space, the opening portion being formed at a position corresponding to an installation position of the maintenance target; and a door portion allowing the opening portion to be opened and closed.

### Advantageous Effects of Invention

According to the present disclosure, it is possible to improve the efficiency of maintenance work.

### BRIEF DESCRIPTION OF DRAWINGS

FIG. 1 is a schematic diagram illustrating an example of a truck according to an aspect of an embodiment of the present disclosure;

FIG. 2 is a schematic diagram illustrating an example of a bus according to an aspect of a variation of the present disclosure; and

FIG. 3 is a schematic diagram illustrating an example of a bus according to an aspect of another variation of the present disclosure.

### DESCRIPTION OF EMBODIMENTS

Hereinafter, an embodiment of the present disclosure will be described with reference to the drawings. Note that, in all the drawings, an element the same as a precedent element is given the same reference numeral, and the description thereof may be omitted.

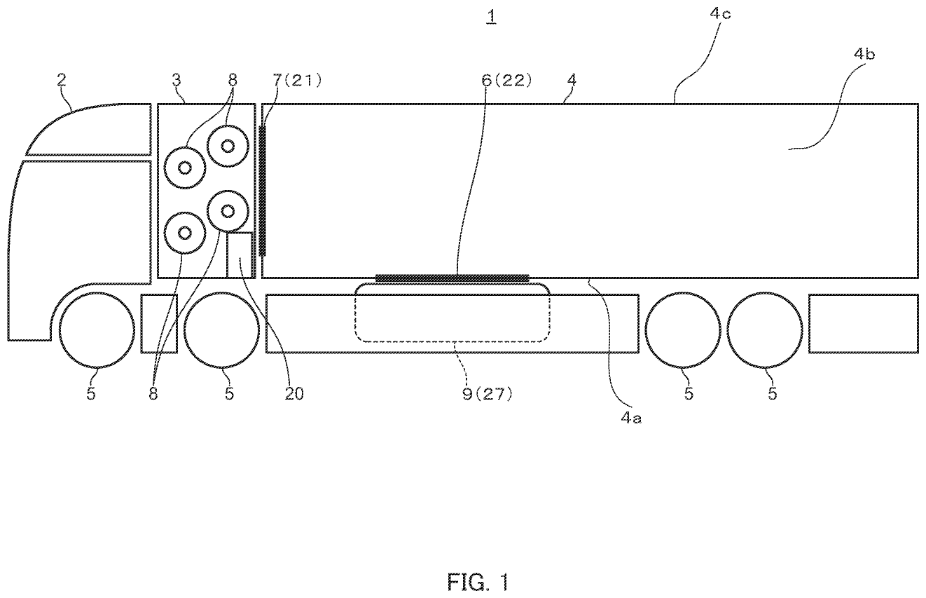

Truck 1 (an example of the automobile) according to the present embodiment will be described with reference to FIG. 1. FIG. 1 is a schematic diagram illustrating an example of truck 1 according to the present embodiment. In FIG. 1, the left side of the figure is the front of truck 1 and the right side of the figure is the rear of truck 1.

Here, a case where truck 1 is a Fuel Cell Vehicle (FCV) will be exemplified, but the present invention is not limited thereto.

As illustrated in FIG. 1, truck 1 includes cab 2, hydrogen tank chamber 3, cargo compartment 4 (an example of the space) as a truck body, and wheels 5. Further, although not illustrated, a Fuel Cell System (FCS) is provided below cab 2.

Cab 2, hydrogen tank chamber 3, and cargo compartment 4 are fixedly disposed on a chassis frame (whose reference sign is omitted) disposed below them. Further, the chassis frame is provided with drive unit 9 including a motor, a gear, a control apparatus, and the like (all of which are not illustrated in the figure), battery 27, and the like.

Hydrogen tank chamber 3 is, for example, a box-shaped housing. Cooling water tank 20 for storing cooling water for cooling various apparatuses is disposed in hydrogen tank chamber 3. Further, a plurality of hydrogen tanks 8 are arranged sideways (in other words, along the vehicle width direction) in hydrogen tank chamber 3.

Hydrogen (an example of fuel) is stored in each of hydrogen tanks 8. Although not illustrated, each of hydrogen tanks 8 and the fuel cell system are connected to each other via a pipe (which may include a joint). Thus, hydrogen in each of hydrogen tanks 8 is supplied to the fuel cell system.

The fuel cell system generates electric power using hydrogen supplied from hydrogen tanks 8. Although not illustrated in the figured, the fuel cell system includes a fuel cell stack and auxiliary devices (for example, an air-compressor, a DC-DC converter, and the like). The motor included in drive unit 9 is driven using the electric power supplied from the fuel cell system. By driving of the motor, truck 1 travels.

Although the above is a basic configuration, truck 1 of the present embodiment is characterized in that, as illustrated in FIG. 1, floor portion 4a (an example of the constituent portion of the space) of cargo compartment 4 is provided with opening portion 22 formed at a position corresponding to an installation position of drive unit 9 (an example of the maintenance target) or battery 27 (an example of the maintenance target) disposed on the outside the floor portion, and door portion 6 that allows the opening portion to be opened and closed. Note that the corresponding position may be a position where the entire maintenance target can be visually recognized, or may be a position where a part of the maintenance target can be visually recognized (the same applies hereinafter).

Further, as illustrated in FIG. 1, truck 1 of the present embodiment is characterized in that, side wall portion 4b of cargo compartment 4 (an example of the constituent portion of the space) is provided with opening portion 21 formed at a position corresponding to the installation position of hydrogen tanks 8 and cooling water tank 20 (both of which are examples of the maintenance target) in hydrogen tank chamber 3 disposed outside the side wall portion, and door portion 7 that allows the opening portion to be opened and closed.

Door portions 6 and 7 may be, for example, of an inward-opening type or a sliding door type. Optionally, door portions 6 and 7 may be attachable to and detachable from the opening portions.

In addition, it is assumed that hydrogen tank chamber 3 is provided with an opening portion at a position facing door portion 7.

As described above, since truck 1 of the present embodiment is provided with the opening portions and door portions 6 and 7, an operator can easily touch the maintenance targets (for example, hydrogen tanks 8, cooling water tank 20, drive unit 9, battery 27, and the like) installed at positions hard to be reached from the inside of cargo compartment 4. Thus, the efficiency of the maintenance work can be improved. The constituent portions of the space may be ceiling portion 4c of cargo compartment 4.

Truck 1 of the present embodiment has been described above.

Note that the present disclosure is not limited to the description of the above-described embodiment, and various modifications can be made without departing from the gist thereof. In the following, variations will be described.

### [Variation 1]

The shapes, installation positions, and numbers of opening portions and door portions are not limited to those illustrated in FIG. 1. These may be determined as appropriate so that the operator can easily touch the maintenance targets.

### [Variation 2]

The embodiment has been described in relation to the exemplary case in which hydrogen tanks 8 are disposed in hydrogen tank chamber 3 which is a box-shaped housing, but the present invention is not limited thereto. For example, the plurality of hydrogen tanks 8 may be disposed on a rack or the like disposed on a flat table.

### [Variation 3]

The embodiment has been described in relation to the exemplary case in which the automobile of the present disclosure is a truck, but the present disclosure is not limited thereto.

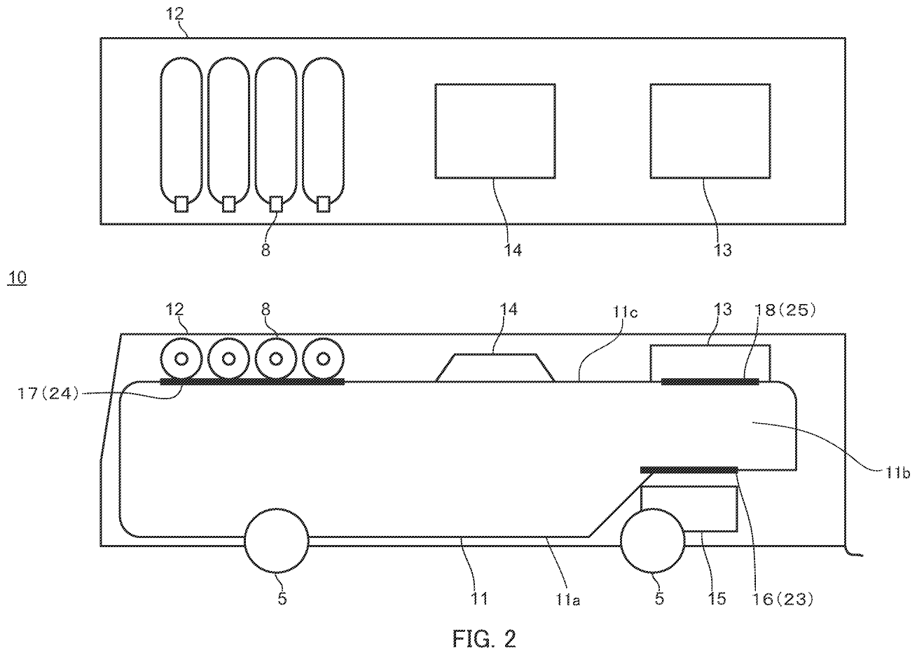

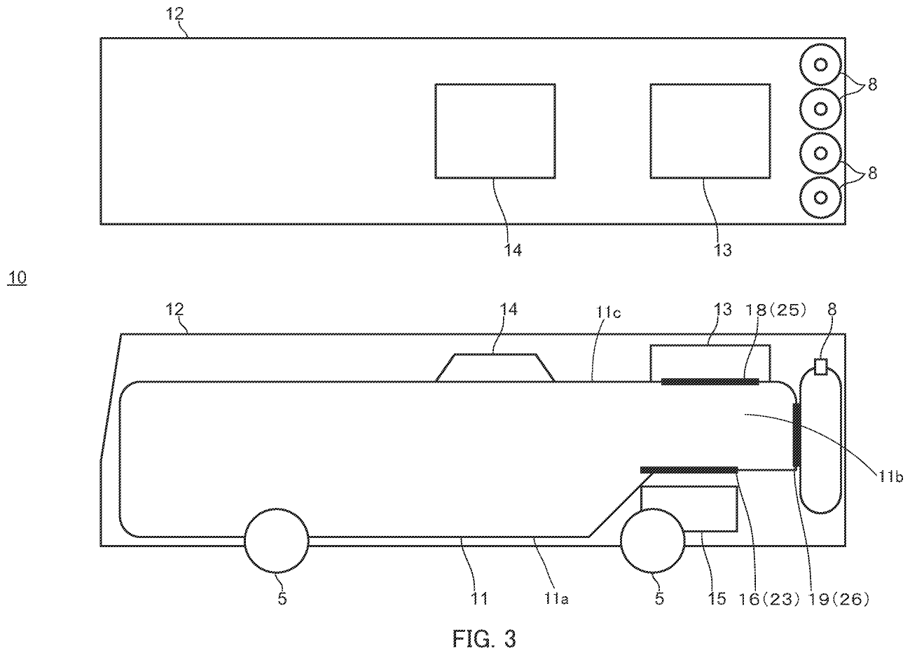

Hereinafter, a case where the automobile of the present disclosure is a bus will be described with reference to FIGS. 2 and 3. FIGS. 2 and 3 are top views and side views illustrating first and second configuration examples of bus 10, respectively. In FIGS. 2 and 3, components common to those in FIG. 1 are denoted by the same reference numerals. In FIGS. 2 and 3, the left side of the figure is the front of bus 10, and the right side of the figure is the rear of bus 10.

To begin with, a first configuration example of bus 10 will be described with reference to FIG. 2.

Bus 10 has interior space 11 provided with a driver's seat, a passenger seat, and the like. Exterior space 12 is disposed above interior space 11 and below the rear portion of interior space 11.

A plurality of hydrogen tanks 8, air conditioner 14, and fuel cell system 13 are installed in upper-side exterior space 12. Hydrogen tanks 8 are installed sideways. Further, drive unit 15 is installed in exterior space 12 below the rear portion of the interior space.

As illustrated in FIG. 2, bus 10 of the present variation is characterized in that ceiling portion 11c of interior space 11 (an example of the constituent portion of the space) is provided with opening portions 24 and 25 formed at positions corresponding to the respective installation positions of hydrogen tanks 8 and fuel cell system 13 (both of which are examples of the maintenance target) disposed outside the ceiling portion, and door portions 17 and 18 that allow opening portions 24 and 25 to be opened and closed.

Further, as illustrated in FIG. 2, bus 10 of the present variation is characterized in that floor portion 11a of interior space 11 (an example of the constituent portion of the space) is provided with opening portion 23 formed at a position corresponding to the installation position of drive unit 15 (an example of the maintenance target) disposed outside the floor portion, and door portion 16 that allows opening portion 23 to be opened and closed.

Door portions 16 to 18 may be, for example, of an inward-opening type or a sliding door type. Optionally, door portions 16 to 18 may be attachable to and detachable from opening portions 23 to 25.

Next, a second configuration example of bus 10 will be described with reference to FIG. 3. In FIG. 3, components common to those in FIG. 2 are denoted by the same reference numerals.

The present example differs from the first configuration example (see FIG. 2) described above in that the plurality of hydrogen tanks 8 are vertically installed at a rear end portion of exterior space 12.

As illustrated in FIG. 3, bus 10 of the present variation is characterized in that ceiling portion 11c (an example of the constituent portion of the space) of interior space 11 is provided with opening portion 25 formed at a position corresponding to an installation position of fuel cell system 13 (an example of the maintenance target) disposed outside the ceiling portion, and door portion 18 that allows opening portion 25 to be opened and closed.

Further, as illustrated in FIG. 3, bus 10 of the present variation is characterized in that floor portion 11a of interior space 11 (an example of the constituent portion of the space) is provided with opening portion 23 formed at a position corresponding to the installation position of drive unit 15 (an example of the maintenance target) disposed outside the floor portion, and door portion 16 that allows opening portion 23 to be opened and closed.

Further, as illustrated in FIG. 3, bus 10 of the present variation is characterized in that side wall portion 11 of interior space 11 (an example of the constituent portion of the space) is provided with opening portion 26 formed at a position corresponding to the installation position of hydrogen tanks 8 (an example of the maintenance target) disposed outside the side wall portion, and door portion 19 that allows opening portion 26 to be opened and closed.

Door portion 19 may be, for example, of an inward-opening type, a sliding door type, or a slide type. Optionally, door portion 19 may be attachable to and detachable from opening portion 26.

As described above, since opening portions 23 to 26 and door portions 16 to 19 are installed in bus 10 of the present variation, an operator can easily touch the maintenance targets (for example, hydrogen tanks 8, fuel cell system 13, drive unit 15, and the like) installed at positions hard to be reached from the inside of interior space 11. Thus, the efficiency of the maintenance work can be improved.

### [Variation 4]

The embodiment and Variation 3 have been describe in relation to the exemplary case in which the vehicle of the present disclosure is a truck or a bus, but the present disclosure is not limited thereto. In addition, the automobile of the present disclosure is not limited to a fuel cell vehicle.

For example, the automobile of the present disclosure may be a body-equipped vehicle including a cab and a platform being a truck body, in which a working machine (for example, a crane, a ladder, or the like) is placed on the platform. In this case, the opening portion and the door portion are provided, for example, in or on a floor portion (which may be referred to as a pedestal portion) on which the work machine is placed.

### INDUSTRIAL APPLICABILITY

The automobile of the present disclosure is useful for improving the efficiency of maintenance work for maintaining a maintenance target.

1. An automobile including a space for accommodating a person or an object, and a maintenance target installed outside a constituent portion of the space, the automobile comprising:
an opening portion in the constituent portion of the space, the opening portion being formed at a position corresponding to an installation position of the maintenance target; and
a door portion allowing the opening portion to be opened and closed.

2. The automobile according to claim 1, wherein:
the automobile is a truck in which a cab and a cargo compartment as the space are fixedly disposed on a chassis frame, and
the constituent portion of the space is at least one of a floor portion, a side wall portion, and a ceiling portion of the cargo compartment.

3. The automobile according to claim 2, wherein
the maintenance target installed outside the side wall portion is a tank for storing fuel used for generating electric power in a fuel cell system or a tank for storing cooling water for cooling various apparatuses.

4. The automobile according to claim 2, wherein
the maintenance target installed outside the floor portion is a drive unit or a battery disposed on the chassis frame.

5. The automobile according to claim 1, wherein:
the automobile is a bus including an interior space as the space, and
the constituent portion of the space is at least one of a floor portion, a side wall portion, and a ceiling portion of the interior space.

6. The automobile according to claim 1, wherein:
the automobile is a body-equipped vehicle equipped with a cab and a working machine, and
the constituent portion of the space is a floor portion on which the working machine is installed.
